(19) United States
(12) Patent Application Publication
(10) Pub. No.: US 2005/0111620 A1
(43) Pub. Date: May 26, 2005

(54) Method and system for remote operation of a medical imaging system

(76) Inventors: Glyn C. Livermore, Milwaukee, WI (US); Girish Kumar Muralidharan, Pewaukee, WI (US)

Correspondence Address: Patrick S. Yoder;FLETCHER YODER, P.O. Box 692289, Houston, TX, 77269-2289, US

(21) Appl. No.: 10/723,087

(22) Filed: Nov. 25, 2003

(51) Int. Cl. G01N 23/04

(52) U.S. Cl. 378/63

(57) ABSTRACT

A technique is provided for providing information about the local environment of an imaging system to a remote operator of the imaging system. The information may be provided by one or more local sensors situated about the imaging system, such as video cameras, microphones, pressure sensors, or climatological sensors, or by one or more local operators. The information may provide the remote operator with indications of the presence or absence of a patient or personnel in the imaging system environment, indications of the position of moving components of the imaging system, and/or indications of the climatological conditions at the site of the imaging system. The remote operator may operate or activate the imaging system in view of the available information concerning the local environment of the imaging system.

### BACKGROUND OF THE INVENTION

The present invention relates generally to the remote monitoring and/or operation of a mechanical and/or radiological system. More specifically, the present invention relates to the remote monitoring and/or operation of a medical imaging system based on information obtained locally at the imaging system.

A wide variety of medical imaging technologies, such as digital X-ray, tomosynthesis, X-ray mammography, computed tomography (CT), positron emission tomography (PET), electron beam tomography (EBT), magnetic resonance imaging (MRI), and so forth, have become commonplace at both large and small medical facilities. Though the number of imaging systems associated with these technologies has steadily increased, the number of personnel qualified to service these systems or to instruct new technicians in their use has not increased at the same rate. Furthermore, because medical imaging systems have become more commonplace at rural or less centralized locations, it may be costly to support a service or instructional infrastructure composed of traveling technicians or instructors.

One alternative is to allow engineers and/or instructors to interact with imaging systems and facility personnel remotely. In this manner, travel time and costs associated with servicing remote, or even local, medical facilities may be reduced or eliminated. For example, a remote engineer may access the imaging system to perform diagnostic routines, to configure the settings used to acquire an image, to view problem images generated by facility personnel, and so forth. Similarly, a remote instructor or technician may access the imaging system to demonstrate the settings appropriate for particular patient conditions or to demonstrate the effect of varying particular system settings in response to image irregularities or artifacts.

This alternative may be unacceptable, however, due to problems associated with remote access to the imaging system. For example, a remote engineer or instructor may be able to see the user interface for the imaging system remotely, but will not be able to see the imaging device or scanner itself or the location of patients or facility personnel in relation to the device or scanner. As a result, a remote engineer or instructor may improperly move a component of the imaging system, such as a CT table or gantry, or initiate the emission of radiation or the generation of a magnetic field when the patient or personnel are not properly positioned. Furthermore, it may be desirable for the remote operator to be able to ascertain other environmental conditions, such as temperature and/or humidity, which may be relevant in diagnosing a problem with the imaging system. It is therefore desirable to allow remote servicing and instruction to be performed on a medical imaging system while providing information to the remote operator concerning the environment at the site of the imaging system.

### BRIEF DESCRIPTION OF THE INVENTION

The present invention relates generally to providing for the remote monitoring and operation of a medical imaging system or other system using information obtained locally at the site of the system. In particular, the technique provides for obtaining information pertaining to the environment at the site of the medical imaging system and conveying the information to a remote operator. The information may be obtained by one or more local operators who convey the information to the remote operator via a network connection, a satellite connection, a voice line, a data line, or other means of communication. The information may be conveyed by these means visually, audibly, and/or textually. Alternatively, no local personnel may be employed at the site of the imaging system to ascertain and convey information to the remote operator. Instead, one or more remote sensors, such as cameras, microphones, pressure sensors, thermometers, hygrometers, and so forth, may be situated at the local site. The information obtained by the local sensors, i.e., measurements, images, sounds, and so forth, may be conveyed to a remote operator via one or more of the previously discussed means.

In accordance with one aspect of the present technique, a method for remotely operating an imaging system is provided. In the present technique, information regarding an imaging system environment is provided to a remote location. The imaging system may be activated from the remote location based on the information regarding the imaging system environment. Systems and computer programs that afford functionality of the type defined by this method are also provided by the present technique.

### BRIEF DESCRIPTION OF THE DRAWINGS

The foregoing and other advantages and features of the invention will become apparent upon reading the following detailed description and upon reference to the drawings in which:

FIG. 1 is a general diagrammatical representation of certain functional components of an exemplary generic imaging system configured for remote operation via the present technique;

FIG. 2 is a flowchart depicting steps by which an imaging system may be remotely operated in accordance with the present technique;

FIG. 3 is a general diagrammatical representation of certain functional components of an exemplary CT imaging system in accordance with the present technique; and

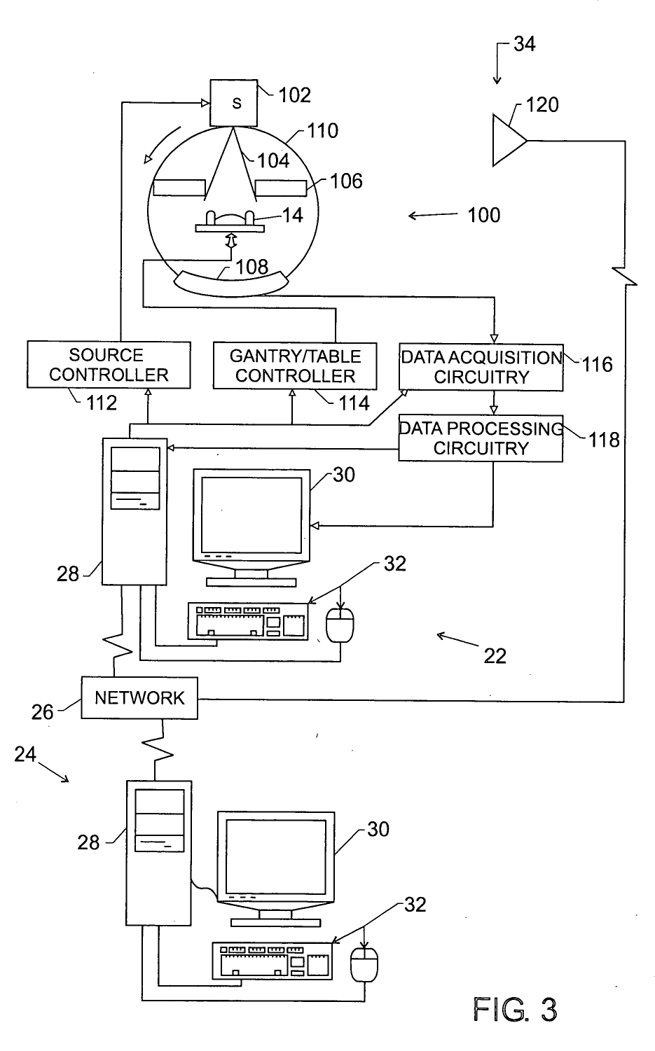

FIG. 4 is a general diagrammatical representation of certain functional components of an exemplary MRI imaging system in accordance with the present technique.

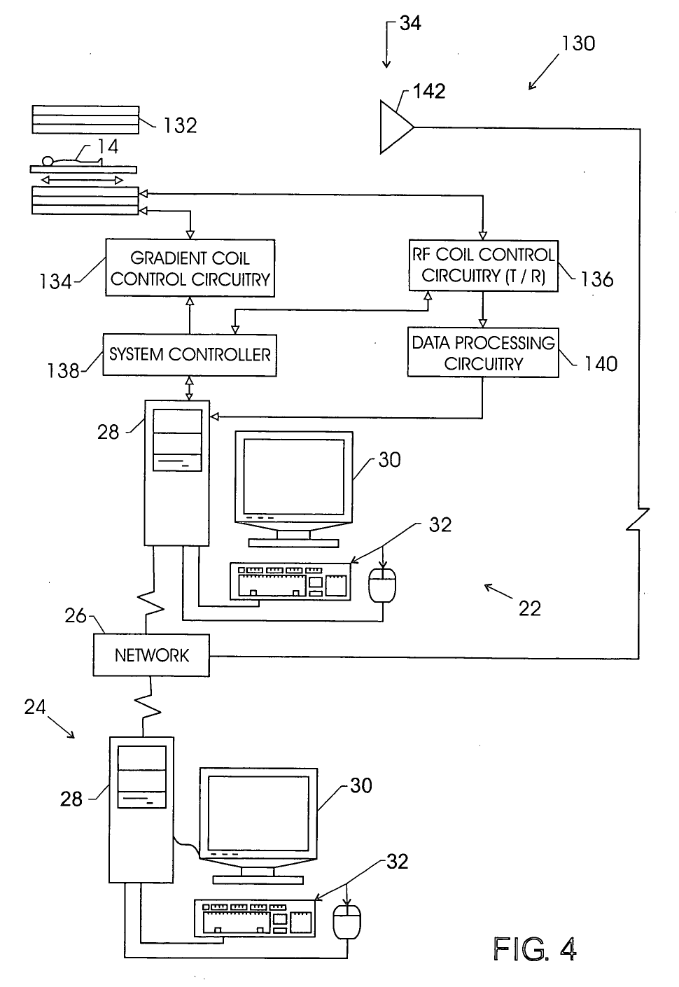

### DETAILED DESCRIPTION OF SPECIFIC EMBODIMENTS

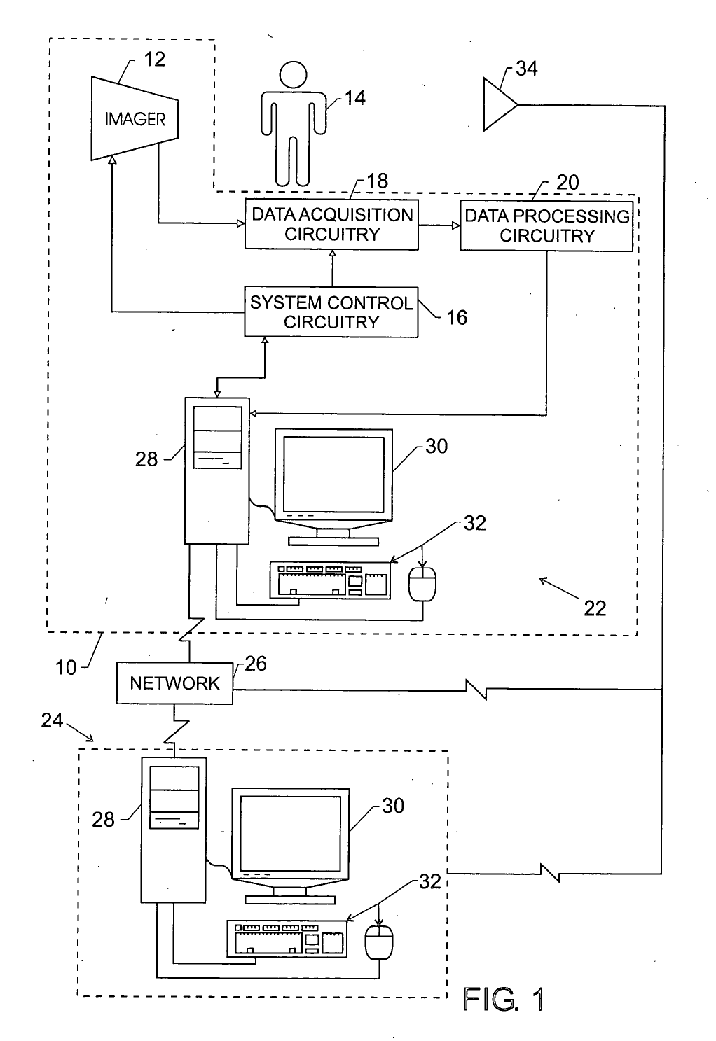

Turning now to the drawings, and referring first to FIG. 1, an exemplary medical imaging system 10 is depicted. Such systems are typically complex and require periodic maintenance of the system 10 and/or periodic instruction of the technicians or personnel using the system 10. The availability of qualified service engineers and/or instructors may be limited, however. The limited numbers of qualified personnel and the prevalence of the imaging systems 10 may, therefore, make remote service or instruction desirable where possible. However, remote operation may be problematic to the extent the remote operator may move components, emit radiation, and/or generate strong magnetic fields when such actions are improper or undesired. These various factors, alone or in combination, contribute to the challenges posed by remote operation of many types of medical imaging systems 10.

Such challenges are addressed in the present technique. In accordance with aspects of the technique, a remote operator, such as a service engineer and/or instructor, may be information concerning the environment of the imaging system. In this manner, the remote operator may properly decide what actions to perform and when to perform them.

For example, returning to FIG. 1, an exemplary medical imaging system 10 is depicted. Generally, the imaging system 10 includes some type of imager 12 that may operate in accordance with various physical principles for creating image data. In general, the imager 12 creates image data representative of regions of interest in a patient 14 either in a conventional support, such as photographic film, or in a digital medium.

The imager 12 operates under the control of system control circuitry 16. The system control circuitry 16 may include a wide range of circuits, such as radiation source control circuits, timing circuits, circuits for coordinating data acquisition in conjunction with patient or table movements, circuits for controlling the position of radiation sources and detectors, and so forth. In the present context, the system control circuitry 16 may also include memory elements for storing programs and routines executed by the system control circuitry 16 or by associated components of the system 10.

The imager 12, following acquisition of the image data or signals, may process the signals, such as for conversion to digital values, and forward the image data to data acquisition circuitry 18. In the case of analog media, such as photographic film, the data acquisition system may generally include supports for the film, as well as equipment for developing the film and producing hard copies that may be subsequently digitized. For digital systems, the data acquisition circuitry 18 may perform a wide range of initial processing functions, such as adjustment of digital dynamic ranges, smoothing or sharpening of data, as well as compiling of data streams and files, where desired. The data may then be transferred to data processing circuitry 20 where additional processing and analysis are performed. For conventional media such as photographic film, the data processing system may apply textual information to films, as well as attach certain notes or patient-identifying information. For the various digital imaging systems available, the data processing circuitry 20 perform substantial analyses of data, ordering of data, sharpening, smoothing, feature recognition, and so forth. The acquired images or image data may be stored in short or long-term storage devices, such as picture archiving communication systems, which may be comprised within or remote from the imaging system 10.

The above-described operations and functions of the imaging system 10 may be controlled by a local operator workstation 22, which typically interfaces with the system control circuitry 16. The local operator workstation 22 may include one or more general purpose or application specific computers 28 or processor-based components. The local operator workstation 22 may include a monitor 30 or other visual display and one or more input devices 32. The monitor 30 and input devices 32 may be used for viewing and inputting configuration information or for operating the imaging system 10, in accordance with the techniques discussed herein. As with the system control circuitry 16, the local operator interface station 22 may comprise or communicate with a memory or data storage component for storing programs and routines executed by the local interface station 22 or by associated components of the system 10. It should be understood that suitable computer accessible memory or storage device capable of storing the desired amount of data and/or code may be accessed by the local operator workstation 22. Moreover, the memory or storage device may comprise one or more memory devices, such as magnetic or optical devices, of similar or different types, which may be local and/or remote to the system 10.

It should be noted that more than a single local operator workstation 22 may be provided. For example, an imaging scanner or station may include an interface which permits regulation of the parameters involved in the image data acquisition procedure, whereas a different operator interface may be provided for manipulating, enhancing, and viewing resulting reconstructed images.

In addition, a remote operator workstation 24 may communicate with the imaging system 10, such as via a network 26. In general, the network 26 allows data exchange between the remote workstation 24 and one or more components of the imaging station 10. As will be appreciated by those skilled in the art, any suitable circuitry, such as modems, servers, firewalls, VPN's and so forth maybe included within the network 26. For example, the network 26 may include one or more of a local intranet within the medical facility, a service network between the facility and a service provider, a direct communication line between the imaging system 10 and the remote workstation 24, a virtual private network established over the Internet, the Internet itself, and so forth.

The remote operator workstation 24 comprises many, if not all, of the components of the local operator workstation 22, such as a monitor 30 and input devices 32. The remote operator workstation 24 allows a remote operator to access elements of the imaging station 10 via the network 26. In particular, the remote operator workstation 24 may allow a remote operator to access or operate the imaging system 10 from the remote site.

However, such remote access or operation may benefit from information concerning the imaging system environment. In particular, because a remote operator cannot visually monitor the physical environment of the imaging system 10, such as the environment around the imager 12, actions or operations that may benefit from such knowledge may be impaired. For example, a remote operator may desire to know the location of personnel and/or patients prior to moving components of the imaging system 10, such as tables, gantries, mechanical arms, and so forth, and/or prior to generating radiation or magnetic fields at the site. Similarly, a remote operator performing diagnostic operations on the imaging system 10 may desire to know temperature, humidity, or other climatological conditions at the local site that may be useful in diagnosing a fault condition of the imaging system 10.

Knowledge of the imaging system environment may be determined by one or more local sensors 34 positioned proximate to the imaging system 10, such as near the imager 12. The local sensors 34 may include a visual monitoring device, such as a video or still camera or a webcam, an audio monitoring device, such as a microphone, and/or a pressure monitoring device, such as a pressure sensitive pad or cushion. Such local sensors 34 may be accessed by a remote operator to examine the imaging system environment to determine the presence or location of personnel, patients, and/or moving components of the imaging system 10. The local sensors 34 may also include climatological monitoring devices, such as thermometers, thermocouples, and/or hygrometers, which may be accessed by a remote operator to ascertain the temperature, humidity, and so forth at the site of the imaging system 10. Other local sensors 34 may of course be possible and may be specified based on the desired environmental parameter to be remotely monitored, as will be appreciated by one of ordinary skill in the art.

The local sensors 34 may provide information to the remote operator via the network 26, either by directly accessing the network 26 or via one or more components of the imaging system 10. Alternatively, the local sensors 34 may be in direct communication with the remote workstation 24 or the remote operator, such as via a direct phone line, a satellite or cell link, or some other mode of direct communication.

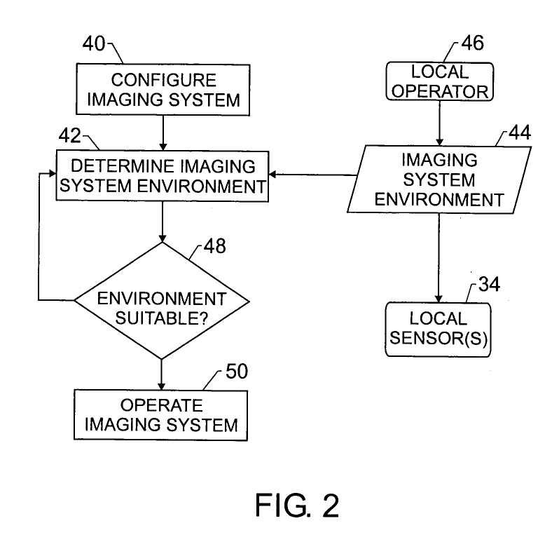

The remote operator may use information obtained via the one or more local sensors 34 to remotely operate the imaging system 10, as depicted in FIG. 2. For example, referring to FIG. 2, the remote operator may configure or otherwise prepare the imaging system 10 for operation, as depicted at step 40. For example, the remote operator may configure the imaging system 10 to implement a desired radiological protocol for diagnostic purposes, such as to calibrate the imaging system 10 or to troubleshoot a reported fault condition. The remote operator may then determine whether the imaging system environment is clear of patients and/or personnel, that the moving components of the imaging system 10 are properly positioned, or that the climatological conditions are within tolerance for the imaging system 10, as depicted at step 42. The remote operator may make this determination based upon imaging system environment information 44 supplied by a local operator 46 or technician and/or by one or more local sensors 34. For example, if a local operator 46 provides the imaging system environment information 44 to the remote operator, the local operator 46 may simply visually confirm the absence of personnel or patients in the proximate imaging system environment and the readiness of the imaging system 10. The local operator 46 may then convey the information concerning the imaging system environment 44 to the remote operator, such as over the phone, as voice-over-internet (VOI), or as a text message relayed via the network 26.

The imaging system environment information 44 may also be obtained via the one or more local sensors 34. For example, the imaging system environment information 44 may consist of video images of the examination area obtained by one or more video cameras. The video images may be relayed to the remote operator via the network 26 or via a direct connection, such as a satellite link. Alternatively the local sensors 34 may provide imaging system environment information 44 to the remote operator in the form of audio or climatological information, depending on the nature of the respective local sensor 34.

If, at step 42, the remote operator determines that the imaging system environment is not acceptable, as depicted at decision block 48, the remote operator may continue to monitor incoming imaging system environment information 44 until a suitable environment is present. If, however, the remote operator determines that the imaging system environment is acceptable at decision block 48, the imaging system may be operated by the remote operator at step 50. In this manner, a remote operator may perform service or other functions on the imaging system 10 while maintaining awareness of the environment around the imaging system 10.

Though the present technique has been discussed in regard to general imaging technologies, one of ordinary skill in the art will readily appreciate how it may be adapted to specific imaging modalities. For example, the present technique may be applied to computed tomography (CT) systems to allow remote operation of the imaging system in view of the immediate environment. Referring to FIG. 5, an exemplary computed tomography (CT) imaging system 100 that may utilize the present technique is depicted. As one of ordinary skill in the art will appreciate, the CT imaging system 100 includes a radiation source 102, which is configured to generate X-ray radiation in a fan or cone-shaped beam 104. A collimator 106 defines limits of the radiation beam. The radiation beam 104 is directed toward a detector 108 made up of an array of photodiodes and transistors which permit readout of charges of the diodes depleted by impact of the radiation from the source 102. Radiation source 102, collimator 106 and detector 108 may be mounted on a rotating gantry 110 that enables them to be rotated about a subject, typically at speeds approaching two or more rotations per second. Configurations of CT imaging systems 100 which differ from that depicted in FIG. 5 are also possible, as one of ordinary skill in the art will appreciate. For example, in some configurations the detector 108 may comprise a ring of detector elements that does not rotate. These and other alternative configurations, such as electron beam tomography (EBT), are well within the scope of the present techniques.

In the depicted configuration, the source 102 and detector 108 are rotated during an examination sequence, generating a series of view frames at angularly displaced locations around a patient 14 positioned within gantry 110. A number of view frames (e.g. between 500 and 1000) are collected for each rotation, and a number of rotations may be made, such as in a helical pattern as the patient 14 is slowly moved along the axial direction of the system 100. For each view frame, data is collected from individual pixel locations of detector 108 to generate a large volume of discrete data. A CT source controller 112 regulates operation of radiation source 102, while a gantry/table controller 114 regulates rotation of gantry 110 and control of movement of patient 14. As will be appreciated by one skilled in the art, in the described configuration, the CT source controller 112 and the gantry/table controller 114 comprise the system control circuitry 16 discussed in FIG. 1.

Data collected by detector 108 may be digitized and forwarded to data acquisition circuitry 116. Data acquisition circuitry 116 may perform initial processing of the data, such as for generation of a data file. The data file may incorporate other useful information, such as relating to cardiac cycles, positions within the system at specific times, and so forth. Data processing circuitry 118 then receives the data and performs a wide range of data manipulation and computations. In general, all or part of the data acquired by the CT scanner can be reconstructed into useful images in a range of manners known to one of ordinary skill in the art. In particular, reconstruction of the data into useful images typically includes computations of projections of radiation on detector 108 and identification of relative attenuations of the data by specific locations within patient 14. The raw, the partially processed, and the fully processed data may be forwarded for post-processing, storage and image reconstruction. The data may be available immediately to an operator, such as at a local operator workstation 22, and may be transmitted remotely via network 26, such as to a remote operator workstation 24. Similarly, configuration and operation commands and instructions may be provided to the source and gantry/table controllers 112, 114 via the local or remote operator interfaces 22, 24.

In the present example, a local sensor 34 may also be present with the CT imaging system 100. The depicted local sensor 34 is a video camera 120, such as a web cam or other network accessible video camera. The video camera 120 may communicate to the remote workstation 24 by directly accessing the network 26, as depicted, or via the CT system 100 or via a dedicated line or communication link. Information received from the video camera may be used by a remote operator during remote operation of the CT system 100, as discussed above, such as to provide remote service to the CT system 100.

Another example of an imaging system 10 is a magnetic resonance imaging (MRI) system 130, represented diagrammatically in FIG. 6. The MRI system 130 includes an MR scanner 132 in which a patient 14 is positioned for acquisition of image data. The scanner 132 generally includes a primary magnet for generating a magnetic field that influences gyromagnetic materials within the patient's body. As the gyromagnetic material, typically water and metabolites, attempts to align with the magnetic field, gradient coils produce additional magnetic fields that are orthogonally oriented with respect to one another. The gradient fields effectively select a slice of tissue through the patient for imaging, and encode the gyromagnetic materials within the slice in accordance with phase and frequency of their rotation. A radio-frequency (RF) coil in the scanner generates high frequency pulses to excite the gyromagnetic material and, as the material attempts to realign itself with the magnetic fields, magnetic resonance signals are emitted which are collected by the radio-frequency coil.

The scanner 132 is coupled to gradient coil control circuitry 134 and to RF coil control circuitry 136. Gradient coil control circuitry 134 permits regulation of various pulse sequences that define imaging or examination methodologies used to generate the image data. Pulse sequence descriptions implemented via gradient coil control circuitry 134 are designed to image specific slices, anatomies, as well as to permit specific imaging of moving tissue, such as blood, and defusing materials. The pulse sequences may allow for imaging of multiple slices sequentially, such as for analysis of various organs or features, as well as for three-dimensional image reconstruction. RF coil control circuitry 136 permits application of pulses to the RF excitation coil, and serves to receive and partially process the resulting detected MR signals. It should also be noted that a range of RF coil structures may be employed for specific anatomies and purposes. In addition, a single RF coil may be used for transmission of the RF pulses, with a different coil serving to receive the resulting signals.

Gradient and RF coil control circuitries 134 and 136 function under the direction of an MR system controller 138. The MR system controller 138 implements pulse sequence descriptions that define the image data acquisition process. The MR system controller 138 will generally permit some amount of adaptation or configuration of the examination sequence by means of a local operator interface 22 or remote operator interface 24, in accordance with the technique described herein.

Data processing circuitry 140 receives the detected MR signals and processes the signals to obtain data for reconstruction. In general, the data processing circuitry 140 digitizes the received signals, and performs a two-dimensional fast Fourier transform on the signals to decode specific locations in the selected slice from which the MR signals originated. The resulting information provides an indication of the intensity of MR signals originating at various locations or volume elements (voxels) in the slice. Each voxel may then be converted to a pixel intensity in image data for reconstruction. Data processing circuitry 140 may perform a wide range of other functions, such as for image enhancement, dynamic range adjustment, intensity adjustments, smoothing, sharpening, and so forth. The resulting processed image data is typically forwarded to the local operator interface 22 for viewing, and/or for short or long-term storage. As in the case of the foregoing imaging systems, MR image data may be viewed locally at a scanner location, or may be transmitted to remote locations, such as the remote operator interface 24, both within an institution and remote from an institution such as via network 26.

A local sensor 34 may be present with the MRI system 130. The local sensor may be a video camera, as discussed with regard to the CT system 100, or other type of measurement and/or monitoring device as discussed herein. For example, the local sensor 34 may be a thermometer or thermocouple 142 which may communicate with the remote workstation 24, such as via the network 26 or a dedicated line. The information obtained by the thermocouple may be used by a remote operator in servicing the MRI system 130, such as in assessing the efficacy of the cryogenic systems or magnet efficiency from the output of one or more diagnostic routines.

In addition to MR and CT systems, other medical imaging modalities may benefit from the present technique, as will be appreciated by one of ordinary skill in the art. For example, tomosynthesis, electron beam tomography (EBT), positron emission tomography (PET), and nuclear medicine systems may benefit from limited remote operator access for service or instruction. The use of remotely accessible local sensors 34 in the environment of such imaging systems, as discussed herein, may provide local environment information that may be useful or beneficial to the remote operator in the course of providing service or instruction.

The technique disclosed herein, however, is not limited to the specific applications described, but may be applied in other contexts as well. For instance, the technique may be employed with imaging devices outside the medical field, such as in part inspection, package or baggage inspection, and quality control. Indeed, the technique may be employed with any device that may benefit from the implementation of remote access, such as for training or service, in which knowledge of the local environment may be useful to the remote operator.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for remotely operating an imaging system, comprising:
providing information regarding an imaging system environment to a remote location; and
activating the imaging system from the remote location based on the information regarding the imaging system environment.

2. The method as recited in claim 1, wherein information regarding the imaging system environment comprises at least one of a video, one or more images, an audible indicator, a textual message, a temperature, and a humidity.

3. The method as recited in claim 1, wherein information regarding the imaging system environment comprises one or more indicia of the presence of a person.

4. The method as recited in claim 1, wherein information regarding the imaging system environment comprises one or more indicia of the position of a moving component of the imaging system.

5. The method as recited in claim 1, wherein providing information comprises transmitting the information over at least one of a network and a dedicated line.

6. The method as recited in claim 1, wherein the remote location is a remote service facility.

7. The method as recited in claim 1, wherein the imaging system comprises one of a CT imaging system, an MR imaging system, an EBT imaging system, a tomosynthesis imaging system, a PET imaging system, and a digital X-ray imaging system.

8. The method as recited in claim 1, further comprising acquiring the information regarding the imaging system environment from at least one of a local operator and one or more local sensors.

9. The method as recited in claim 8, wherein the one or more local sensors comprise a video camera, a web cam, a still camera, a microphone, a thermometer, a thermocouple, a pressure sensor, and a hygrometer.

10. A computer program, provided on one or more computer readable media, for facilitating remote operation of an imaging system, comprising:
a routine for providing information regarding an imaging system environment to a remote location; and
a routine for activating the imaging system from the remote location based on the information regarding the imaging system environment.

11. The computer program as recited in claim 10, wherein information regarding the imaging system environment comprises at least one of a video, one or more images, an audible indicator, a textual message, a temperature, and a humidity.

12. The computer program as recited in claim 10, wherein information regarding the imaging system environment comprises one or more indicia of the presence of a person.

13. The computer program as recited in claim 10, wherein information regarding the imaging system environment comprises the position of a moving component of the imaging system.

14. The computer program as recited in claim 10, wherein the imaging system comprises one of a CT imaging system, an MR imaging system, an EBT imaging system, a tomosynthesis imaging system, a PET imaging system, and a digital X-ray imaging system.

15. The computer program as recited in claim 10, further comprising a routine for acquiring the information regarding the imaging system environment from at least one of a local operator and one or more local sensors.

16. The computer program as recited in claim 10, wherein the one or more local sensors comprise a video camera, a web cam, a still camera, a microphone, a thermometer, a thermocouple, a pressure sensor, and a hygrometer.

17. An imaging system, comprising:
a local imaging system, comprising:
an imager configured to detect one or more signals which may be converted into a physiological image;
one or more data acquisition circuits configured to receive and process the one or more signals from the imager;
one or more system control circuits configured to control the imager and the data acquisition circuits;
at least one local workstation configured to communicate with the one or more system control circuits;
a remote workstation configured to communicate with the one or more system control circuits via a network connection; and
one or more local sensors configured to acquire information regarding the local imaging system environment and to transmit the information to the remote workstation.

18. The imaging system as recited in claim 17, wherein the one or more local sensors transmits the information over at least one of a network and a dedicated line.

19. The imaging system as recited in claim 17, wherein the local imaging system comprises one of a CT imaging system, an MR imaging system, an EBT imaging system, a tomosynthesis imaging system, a PET imaging system, and a digital X-ray imaging system.

20. The imaging system as recited in claim 17, wherein the one or more local sensors comprise a video camera, a web cam, a still camera, a microphone, a thermometer, a thermocouple, a pressure sensor, and a hygrometer.

21. An imaging system, comprising:
a local imaging system, comprising:
an imager configured to detect one or more signals which may be converted into a physiological image;
one or more data acquisition circuits configured to receive and process the one or more signals from the imager;
one or more system control circuits configured to control the imager and the data acquisition circuits;
at least one local workstation configured to communicate with the one or more system control circuits;
a remote workstation configured to communicate with the one or more system control circuits via a network connection;
means for providing information regarding the local imaging system environment to the remote workstation.
